(19) United States
(12) Patent Application Publication
(10) Pub. No.: US 2013/0032125 A1
(43) Pub. Date: Feb. 7, 2013

(54) FUEL COOLING SYSTEM FOR DIMETHYL-ETHER FUEL VEHICLE

(71) Applicant: Jongmin Jang, Hwaseong-si (KR)

(72) Inventor: Jongmin Jang, Hwaseong-si (KR)

(73) Assignee: Hyundai Motor Company, Seoul (KR)

(21) Appl. No.: 13/304,048

(22) Filed: Nov. 23, 2011

(30) Foreign Application Priority Data
Aug. 1, 2011 (KR) 10-2011-0076699

(51) Int. Cl. F02M 69/46

(52) U.S. Cl. 123/456

(57) ABSTRACT

A fuel cooling system for a dimethyl-ether fuel vehicle includes a fuel tank storing dimethyl-ether, a fuel supply line introducing the dimethyl-ether into an engine, a fuel supply pump, pressurizing the dimethyl-ether, and sending the pressurized dimethyl-ether to a fuel injection system, a common rail maintaining a pressure of the pressurized dimethyl-ether from the fuel supply pump, a fuel injection system injecting the pressurized dimethyl-ether supplied from the common rail, a fuel return line communicating with and diverging from the fuel injection system, the common rail and/or a downstream side of the fuel supply pump to collect remaining dimethyl-ether, a fuel cooling device disposed in the fuel return line, and a drain pipe to discharge condensed water generated from an evaporator disposed in an air conditioner, wherein discharged condensed water from the drain pipe is supplied to the fuel cooling device and cools the collected dimethyl-ether.

### CROSS-REFERENCE TO RELATED APPLICATIONS

The present application claims priority of Korean Patent Application Number 10-2011-0076699 filed Aug. 1, 2011, the entire contents of which application are incorporated herein for all purposes by this reference.

### BACKGROUND OF INVENTION

1. Field of Invention

The present invention relates to a cooling system, and more particularly, to a fuel cooling system of a dimethyl-ether (DME) fuel vehicle that can optimize fuel cooling performance of the DME fuel vehicle, in which the DME has been developed as a substitute energy.

2. Description of Related Art

In general, a diesel engine used in vehicles has an advantage of having high thermal efficiency and discharging a small amount of carbon dioxide that is a gas causing global warming in comparison to other engines, but has a problem in that it discharges a large amount of particulate materials (PM) and nitride oxides (NOx).

Accordingly, although using a natural gas and liquefied petroleum gas (LPG), as a low-air pollution substitute fuel for the diesel engine, has been actively promoted, there is a problem in that thermal efficiency decreases in comparison to the diesel engine and it is required to reconstruct many parts, including the fuel system, such that dimethyl-ether (DME) has drawn considerable attention as a substitute fuel for the diesel engine.

The DME is an ether compound (CH₃OCH₃) created by bonding of one oxygen molecule and two methane radicals and has been used for a propellant of a spray, production of olefin, Methanol To Gasoline (MTG), and composing of methyl acetate.

The DME has many advantages.

First, since the cetane number is high (about 60), a diesel cycle operation is possible and it is possible to achieve thermal efficiency and the exhaust amount of carbon dioxide at the same level as a diesel engine.

Second, since it is oxygen-containing fuel (34.8 wt %) with no C—C bonding, a small amount of Particulate Material (PM) would be produced.

Third, it is possible to simultaneously implement low NOx and low PM by applying exhaust-gas recirculation (EGR).

Fourth, since it is a colorless and transparent gas at the room temperature and atmospheric pressure and can be liquefied at the room temperature under about 5.3 times of atmospheric pressure, similar handling is possible and it can be used for the fuel containers or the fuel supply systems of current LPG vehicles. As such DME is considered as a favorable next generation low-containment alternate fuel.

In the fuel system of an engine where the DME fuel described above is applied, the fuel temperature is a factor affecting vehicle performance and should be maintained at approximately 40° C. or lower so that it does not negate the engine output and the vehicle can run stably.

That is, the returning DME fuel collected from an engine pumping and injection system is generally at an elevated temperature, typically at 100° C. or above. Due to the properties of the DME fuel, the returning DME fuel should be cooled to and maintained at a low temperature, for example 40° C. or below. To do that, a cooling system must be provided. However, in a season with high external temperature, such as in summer, the cooling effect of a fuel cooling device decreases, the cooling device frequently operates, and the durability and fuel efficiency decrease. It is therefore useful to provide a cooling system with an optimized fuel cooling performance.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are directed to implement a system that enhances cooling effect of a fuel cooling device by collecting cold condensed water produced in an evaporator of an air conditioner.

Exemplary fuel cooling systems of the present invention for a dimethyl-ether fuel vehicle may include a fuel tank storing dimethyl-ether, a fuel supply line introducing the dimethyl-ether into an engine, a fuel supply pump disposed in the fuel supply line, pressurizing the dimethyl-ether, and sending the pressurized dimethyl-ether to a fuel injection system, a common rail maintaining a pressure of the pressurized dimethyl-ether from the fuel supply pump, a fuel injection system injecting the pressurized dimethyl-ether supplied from the common rail, a fuel return line communicating with and diverging from the fuel injection system, the common rail and/or a downstream side of the fuel supply pump to collect remaining dimethyl-ether, a fuel cooling device disposed in the fuel return line, and a drain pipe disposed to discharge condensed water generated from an evaporator disposed in an air conditioner, wherein the discharged condensed water from the drain pipe is supplied to the fuel cooling device and cools the collected dimethyl-ether.

The fuel cooling device may include a heat exchanger and a cooling fan such as an electric cooling fan. The condensed water cools the collected dimethyl-ether in the heat exchanger.

The fuel supply pump may include a low-pressure pump disposed in the fuel supply line and pressurizing the dimethyl-ether from the fuel tank to a first predetermined pressure, and a high-pressure pump disposed at a downstream side of the low-pressure pump and pressurizing the dimethyl-ether to a second predetermined pressure, wherein the second predetermined pressure is higher than the first predetermined pressure.

Various aspects of the present invention for a dimethyl-ether fuel vehicle may include an accumulator disposed at a downstream side of the fuel cooling device for preventing pulsation in the fuel return line, a regulator disposed to communicate with the fuel tank and control a pressure of the collected dimethyl-ether in the fuel return line at a third predetermined pressure, and/or a check valve for preventing a backflow of the collected dimethyl-ether between the regulator and the fuel tank.

According to various aspects of the present invention, it is effective for cooling fuel in summer by allowing cold condensed water to exchange heat with the fuel cooling device.

Further, according to various aspects of the present invention, it is possible to expect reduction of cost because it is possible to reduce the specification of the cooling fan, resulting from reduction of the amount of cooling air in summer.

In addition, according to various aspects of the present invention, it is possible to improve fuel efficiency by reducing the operation load, because the frequency of operation of the electric cooling fan is reduced by maximizing cooling of the fuel by the condensed water.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing an exemplary fuel cooling system for a dimethyl-ether fuel vehicle according to the present invention.

FIG. 2 is a schematic view showing a heat exchanger of an exemplary fuel cooling system for a dimethyl-ether fuel vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

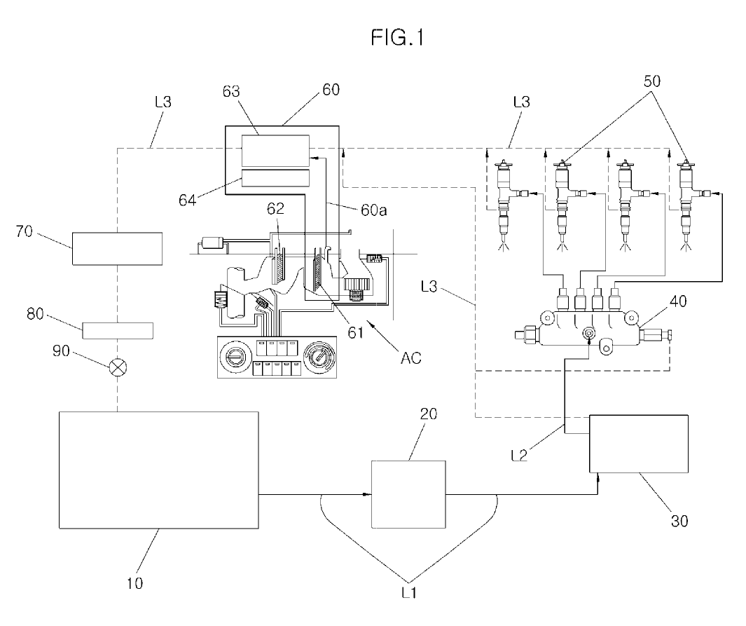

Referring to FIG. 1, the fuel cooling system for a dimethyl-ether (DME) fuel vehicle according to various embodiments of the present invention includes a fuel tank 10, a fuel supply pipe L1, a low-pressure pump 20, a high-pressure pump 30, a common rail 40, a fuel injection system 50, a fuel cooling device 60, an accumulator 70, and a regulator 80.

Fuel tank 10 has a function of storing liquid-state DME fuel. Low-pressure pump 20 that discharges the stored fuel may be disposed in fuel tank 10. In this configuration, although several atmospheric pressure may be sufficient to supply liquid-state DME fuel, it is preferable to use two fuel pumps because the DME fuel may evaporate due to an increase in temperature in high-pressure pump 30 described below.

That is, the DME is sent under pressure by low-pressure pump 20 for primarily discharging the fuel from fuel tank 10 through a low-pressure supply line L1 that communicates with fuel tank 10. The fuel is supplied to high-pressure pump 30 after increasing in pressure to about 20 bar through low-pressure pump 20.

The pressure of the DME fuel that has passed through low-pressure pump 20 is increased to about 900 bar in a high-pressure supply line L2, passing through high-pressure pump 30.

Thereafter, the DME fuel at high pressure, as described above, is temporarily stored at common rail 40 provided to keep the pressure while passing through high-pressure fuel line L2, and is compressed and exploded with air by being injected into the combustion chamber of an engine through fuel injection system 50 from common rail 40.

The fuel collected from the downstream side of high-pressure pump 30, the fuel collected at one end of common rail 40, and the fuel remaining in fuel injection system 50 flow to fuel cooling device 60 (described below) through a fuel return line L3.

Fuel cooling device 60 is provided to cool the fuel at an elevated temperature, as described above, into a stable liquid-state fuel and send it to fuel tank 10.

Fuel cooling device 60 includes a heat exchanger 63 and a cooling fan such as an electric cooling fan 64. An accumulator 70 may be further included to prevent pulsation in fuel return line L3 after cooling the return fuel in the liquid fuel state.

When an air conditioner AC of a vehicle is operated, condensed water is generated from evaporator 61 while the external air passes a heater core 62 through evaporator 61, in air conditioner AC.

A drain pipe 60a is disposed to supply the condensed water to fuel cooling device 60. That is, drain pipe 60a diverges around evaporator 61 of air conditioner AC such that the condensed water from evaporator 61 can be circulated to fuel cooling device 60. As described above, the low-temperature condensed water diverging through drain pipe 60a cools the fuel in fuel cooling device 60 and a specific energy source is not used, such that it is possible to more efficiently cool the DME fuel.

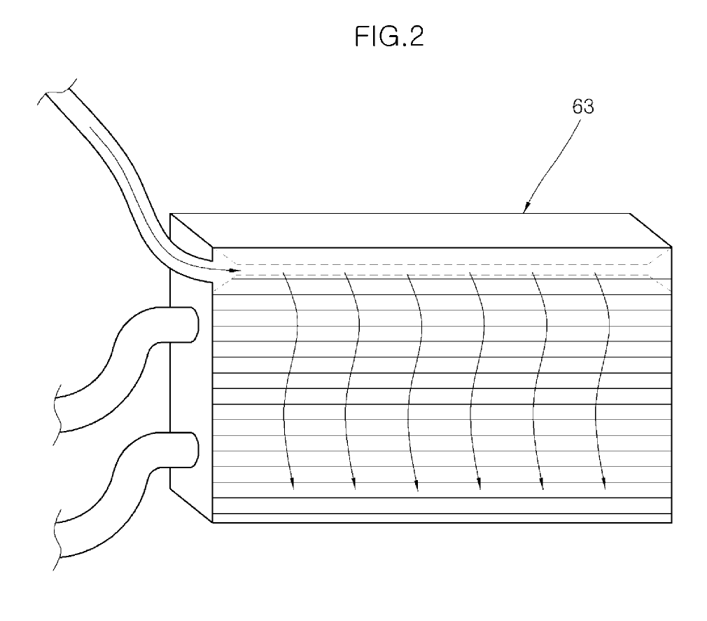

Referring to FIG. 2, the condensed water can exchange heat with returned DME in heat exchanger 63. A structure in which fluid cross each other with a wall therebetween or a heat exchange structure, such as a cooling fan, other than the structure shown in FIG. 2, may be applied. Further, it is possible to enhance the cooling effect of the DME by simultaneously operating electric cooling fan 64 disposed close to heat exchange 63.

It is possible to control the fuel pressure at a uniform level through regulator 80 after accumulator 70.

Thereafter, the returned DME fuel is stored in fuel tank 10. It is possible to prevent backflow by disposing a check valve 90 between fuel tank 10 and regulator 80.

For convenience in explanation and accurate definition in the appended claims, the terms upstream or downstream, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel cooling system for a dimethyl-ether fuel vehicle, comprising:
a fuel tank storing dimethyl-ether;
a fuel supply line introducing the dimethyl-ether into an engine;
a fuel supply pump disposed in the fuel supply line, pressurizing the dimethyl-ether, and sending the pressurized dimethyl-ether to a fuel injection system;
a common rail maintaining a pressure of the pressurized dimethyl-ether from the fuel supply pump;
a fuel injection system injecting the pressurized dimethyl-ether supplied from the common rail;
a fuel return line communicating with and diverging from the fuel injection system, the common rail and/or a downstream side of the fuel supply pump to collect remaining dimethyl-ether;
a fuel cooling device disposed in the fuel return line; and
a drain pipe disposed to discharge condensed water generated from an evaporator disposed in an air conditioner;
wherein the discharged condensed water from the drain pipe is supplied to the fuel cooling device and cools the collected dimethyl-ether.

2. The fuel cooling system for a dimethyl-ether fuel vehicle as defined in claim 1, wherein the fuel cooling device includes a heat exchanger and a cooling fan.

3. The fuel cooling system for a dimethyl-ether fuel vehicle as defined in claim 2, wherein the condensed water cools the collected dimethyl-ether in the heat exchanger.

4. The fuel cooling system for a dimethyl-ether fuel vehicle as defined in claim 1, wherein the fuel supply pump includes:
a low-pressure pump disposed in the fuel supply line and pressurizing the dimethyl-ether from the fuel tank to a first predetermined pressure; and
a high-pressure pump disposed at a downstream side of the low-pressure pump and pressurizing the dimethyl-ether to a second predetermined pressure, wherein the second predetermined pressure is higher than the first predetermined pressure.

5. The fuel cooling system for a dimethyl-ether fuel vehicle as defined in claim 1, further comprising an accumulator disposed at a downstream side of the fuel cooling device for preventing pulsation in the fuel return line.

6. The fuel cooling system for a dimethyl-ether fuel vehicle as defined in claim 1, further comprising a regulator disposed to communicate with the fuel tank and control a pressure of the collected dimethyl-ether in the fuel return line at a third predetermined pressure.

7. The fuel cooling system for a dimethyl-ether fuel vehicle as defined in claim 6, further comprising a check valve for preventing a backflow of the collected dimethyl-ether between the regulator and the fuel tank.
